(19) United States
(12) Patent Application Publication
(10) Pub. No.: US 2004/0021912 A1
(43) Pub. Date: Feb. 5, 2004

(54) Device and method for aligning a portable device with an object

(76) Inventors: Kirk Steven Tecu, Greeley, CO (US); William Robert Haas, Fort Collins, CO (US); Scott Clinton Baggs, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/208,886

(22) Filed: Jul. 30, 2002

(51) Int. Cl. H04N 1/04; H04N 1/047; H04N 1/10

(52) U.S. Cl. 358/473; 358/497; 358/488

(57) ABSTRACT

An imaging device comprising an actuation element externally disposed on the imaging device and a first alignment element communicatively coupled with the actuation element and operable to emit an alignment light upon actuation of the actuation element, the alignment light emitted substantially in parallel with a surface of the imaging device is provided. A method of aligning a portable imaging device with an object comprising actuating an input element operatively coupled to an alignment element and emitting at least one alignment light from the alignment element is provided.

### TECHNICAL FIELD OF THE INVENTION

This invention relates to imaging technologies and, more particularly, to a method and device for facilitating alignment of a hand-held imaging device with an object.

Multi-function peripheral imaging devices are common in today's computing environments. For example, some printing devices (such as laser printers or ink jet printers) are now integrated with copying, scanning and/or faxing devices. However, multifunctional devices are generally large, mechanically- and electronically-complex units. Moreover, numerous scenarios often arise where traditional multi-functional devices are impractical or cumbersome to use. For example, scanning and printing on small media, such as postcards, envelopes, or other relatively small media, is often difficult to perform on conventional multi-functional devices and may require manual adjustments to various media feed guides. Likewise, scanning and/or printing on over-sized media, such as poster-sized media, may be difficult or impossible with conventional scanning or printing office equipment.

Hand-held scanning devices have been developed to facilitate scanning of media that is not easily accommodated by traditional office scanning equipment and to provide an added convenience of remotely scanning a media object. Imaging devices generate machine-readable image data (also referred to herein as image data) representing an image of an object during the imaging process as the device is moved relative to the object being imaged. As the scanning device is moved relative to the object, the scanning device generates image data representing a plurality of sequential scan line portions of the image of the object. The image of the object is, accordingly, represented by the image data of the cumulation of sequential scan lines.

A portable printing device may be used for printing on small print media, such as postcards, envelopes, or other media not easily or efficiently accommodated by conventional peripheral printing devices and to facilitate remote printing on media where office equipment is unavailable. Portable printing devices may use one or more navigation sensors, such a one-dimensional roller sensors or two-dimensional photoelement array sensors. Position information obtained by the navigation sensors is used to track movement of the portable printing device and to coordinate ejection of a print media onto a document or other object.

While navigation technologies greatly facilitate eliminating skew, or other image variances, during scanning with portable scanning devices, accurate alignment of a portable printing device with an area of interest during a print operation remains problematic. For example, accurate printing of the image within the desired print region requires proper visual alignment of the printing device with the object, e.g. a vertical or horizontal axis of a document, and in current hand-held devices often results in misalignment of the printed image with one or more axes of the object.

### SUMMARY OF THE INVENTION

In accordance with an embodiment of the present invention, an imaging device comprising an actuation element externally disposed on the imaging device and a first alignment element communicatively coupled with the actuation element and operable to emit an alignment light upon actuation of the actuation element, the alignment light emitted in parallel with a surface of the imaging device is provided.

In accordance with another embodiment of the invention, a method of aligning a portable imaging device with an object comprising actuating an input element communicatively coupled to an alignment element and emitting at least one alignment light from the alignment element is provided.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a simplified perspective view of a portable imaging device that may have a scan device and/or a printing device integrated therewith according to an embodiment of the present invention.

FIG. 2 is simplified bottom schematic of the device of FIG. 1;

FIG. 3A is a simplified perspective view of a portable imaging device that may have a scan device and/or a printing device integrated therewith according to an embodiment of the present invention;

FIG. 3B is a simplified front schematic of the device described with reference to FIG. 3A;

FIGS. 3C and 3D are, respectively, a left and right side schematic of the device described with reference to FIG. 3A;

FIG. 4 is a simplified block diagram of the device shown and described with reference to FIGS. 3A-3D; and

FIG. 5 is a simplified top schematic of the device of the present invention positioned on a document according to an embodiment of the present invention.

### DETAILED DESCRIPTION OF THE DRAWINGS

The preferred embodiment of the present invention and its advantages are best understood by referring to FIGS. 1 through 5 of the drawings, like numerals being used for like and corresponding parts of the various drawings.

In FIG. 1, there is a simplified perspective view of a portable imaging device 10 that may have a scan device and/or a printing device integrated therewith in which an embodiment of the present invention may be used to advantage. Device 10, in general, has an external housing 20 including an anterior surface 30 and a posterior surface. Surface 30 may have one or more input elements for receiving input from a user of device 10 and/or one or more output elements for providing visual feedback to the user. For example, surface 30 may have one or more keypads 50 and 51 with control button(s) 50A-50C and 51A-51E disposed thereon. Control buttons 50A-50C and 51A-51E may comprise mechanical actuation elements and, accordingly, surface 30 may have one or more apertures disposed thereon such that each of control buttons 50A-50C and 51A-51E may be depressed, or otherwise actuated, such that one or more switches, or other devices, disposed within device 10 respectively activate one or more device 10 subsystems, such as a lighting element, a sensor array, a print controller, a scan controller or another device. Other input elements, such as a touch-sensitive panel, that do not require mechanical actuation, may be substituted for keypads 50 and 51.

An output device 60, such as a liquid crystal display, is preferably disposed on surface 30. Output device 60 is operable to provide visual output to the user of device 10. Output device 60 may provide a visual indication of a selected operational mode, such as a print mode, scan mode or another operational status such as a visual progress indication of a scanned and/or printed image, and/or other information indicative of an operational state of device 10.

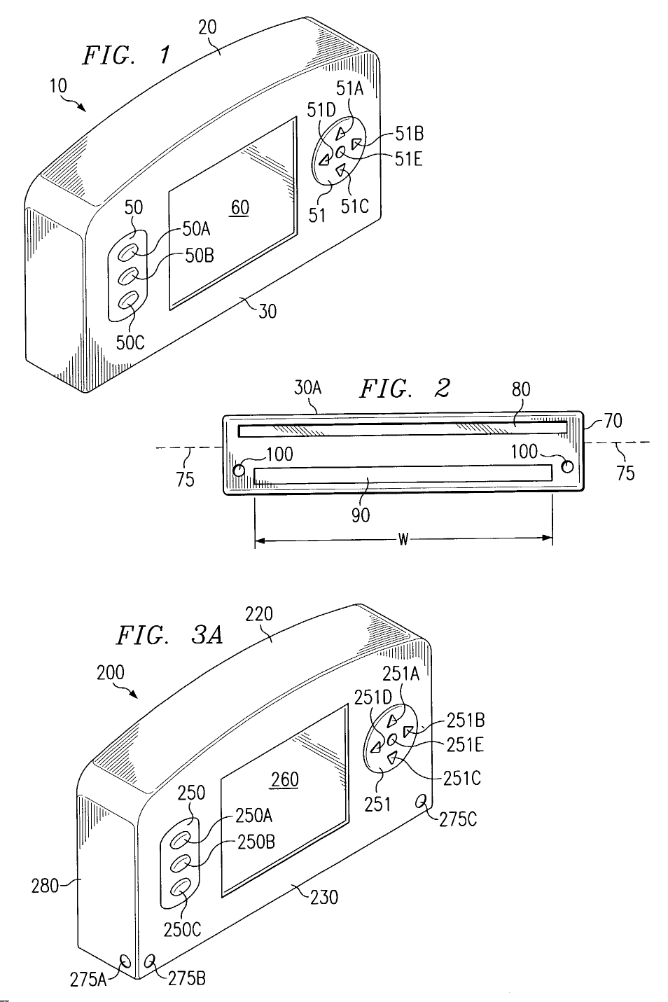

FIG. 2 is a simplified bottom schematic of device 10 operable to perform both scan and print operations. A bottom surface 70 of device 10 may include a transparent panel 80 that facilitates imaging by an imaging device disposed within device 10. Transparent panel 80 may be comprised of any one of numerous commercially-available materials, such as a polycarbonate or another suitable transparent material. Transparent panel 80 is sufficiently translucent such that light emitted from a scanning device disposed within device 10 may pass through panel 80, reflect from a scanned object, and pass back through transparent panel 80 with enough intensity to be detected and processed by the scanning device.

Bottom surface 70 may have one or more navigation sensors 100 disposed thereon. Navigation sensors 100 detect the position of device 10 relative to the scan object. Navigation sensors 100 output position information pertaining to the position of device 10 relative to an object adjacent thereto. The position information generated by navigation sensors 100 is conveyed to a processor where it may be incorporated into a database. The processor receiving and processing the position information may be disposed within device 10 or, alternatively, may be disposed within another device, such as a personal computer, with which device 10 is in communication. A print head 90 having a width (W) may be disposed within device 10 and exposed through bottom surface 70. Print head 90 may comprise an elongate structure generally aligned with a transverse axis 75 of device 10. Prior to scanning and/or printing with device 10, a user may attempt to align device 10 with an axis of a region of interest, such as a longitudinal and/or lateral axis of a document. Heretofore, the user of device 10 has been limited to visually aligning one or more surfaces of device 10 with a region of interest. For example, the user may attempt to align anterior edge 30A with a longitudinal or lateral edge of a document having a surface to be scanned and/or printed on by device 10. Visually aligning surfaces of device 10 with a document or other object is often problematic and misalignment may introduce skew or other undesirable effects in the scanned and/or printed object. Embodiments of the present invention provide a technique for emitting alignment lines from a portable scanner and/or printer device that facilitates more accurate alignment of the device with a region of interest.

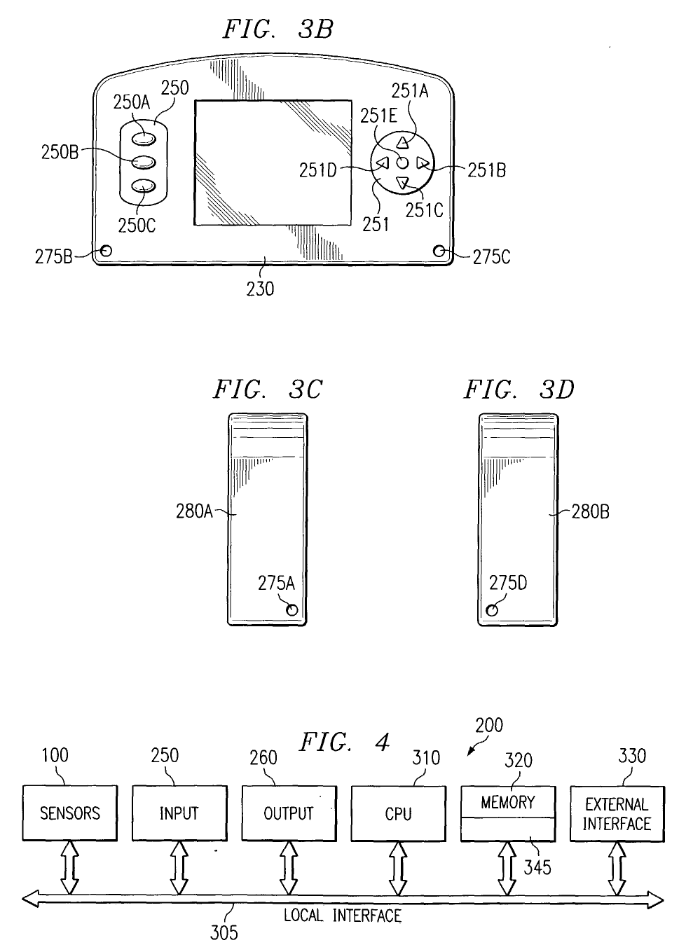

In FIG. 3A, there is a simplified perspective view of a portable imaging device 200 that may have a scan device and/or a printing device integrated therewith according to an embodiment of the present invention. A front, a left side, and right side schematic of device 200 are respectively shown in FIGS. 3B-3D. Device 200, in general, has an external housing 220 including an anterior surface 230 that may have one or more input elements, such as one or more keypads 250 and 251 with control button(s) 250A-250C and 251A-251E, disposed thereon for receiving input from a user of device 200 and/or one or more output elements, such as a liquid crystal display 260, disposed thereon for providing visual feedback to the user. One or more alignment elements 275A-275D operable to emit a respective alignment light are oriented such that alignment of device 200 with a region of interest is facilitated. For example, anterior surface 230 may have light emitted therethrough by alignment element(s) 275B-275C of device 200 such that alignment of device 200 with a desired region of interest is facilitated by projection of alignment lights that may be visually aligned with an edge of a document. Additional alignment element(s), such as alignment element 275A and 275D, may be orthogonally oriented with respect to alignment elements 275B and 275C such that two or more of alignment elements 275A-275D emit and project mutually-orthogonal alignment lights. Each of alignment elements 275A-275D is communicatively coupled with one or more of control button(s) 250A-250C and 251A-251E such that activation of alignment elements 275A-275D is made by actuation of one or more control button(s) 250A-250C and 251A-251E. In a preferred embodiment, alignment elements 275A-275D are laser emitters and are configured such that laser light emitted therefrom is substantially parallel with both a bottom surface and a lateral or longitudinal axis of device 200. For example, alignment element 275B of device 200 may be oriented such that laser light emitted therefrom is parallel to both a bottom surface of device 200 as well as a lateral surface 280 of device 200. Likewise, alignment element 275A may be disposed within device 200 such that laser light emitted therefrom is parallel to both a bottom surface and anterior surface 230 of device 200. Other alignment elements 275A-275D, such as light emitting diodes, may be utilized instead of laser emitters. Preferably, housing 200 includes a respective aperture, for example on surface 230, 280A, and 280B, through which light emitted from each alignment element 275A-275D is projected. In such a configuration, alignment elements 275A-275D are preferably disposed within housing 220. Alternatively, alignment elements 275A-275D may be disposed externally on housing 220.

In FIG. 4, there is a simplified block diagram of device 200 as may be implemented according to an embodiment of the present invention. Device 200 may comprise a processing element 310 such as a central processing unit. Processing element 310 may fetch and execute computer-readable instructions maintained in a memory unit 320, such as a random access memory, a read-only memory, electrically-programmable read only memory, or another storage device, that facilitate control of various device resources through conventional techniques.

Processing element 310 communicates with and drives other elements within device 200 via a local interface 305, which may comprise one or more buses. Furthermore, an input device 330, for example keypads 250 and 251, a keyboard, a touchscreen or another device, can be used to input data from the user of device 200, and an output device 260, for example a liquid crystal display, a CRT display, or another device, can be used to output data to the user. Navigation sensors 100, such as roller mechanisms, optic sensors, or another device operable to detect the position of device 200 relative to an object such as a document to be printed on, may also be coupled to internal interface 305. Navigation sensors 100, in general, detect and track the position of device 200 relative to an object and output position information pertaining to the position of device 200 relative to an object adjacent a bottom surface as device 200 is moved across the object. The position information generated by navigation sensors 100 is conveyed to processing element 310 where it may be processed and/or stored thereby, for example input into a positioning database. Device 200 may additionally comprise one or more external peripheral interfaces 330, such as an infra-red port, and universal serial bus interface, serial or parallel interface, or another conventional peripheral interconnect, through which data may be conveyed to an external device.

In a preferred embodiment, an input key, such as button 250A, is implemented as a multi-positional mechanically-actuated push-button that is operatively coupled with one or more of alignment elements 275A-275D such that depression thereof into a first depressed position actuates one or more of alignment elements 275A-275D and further depression into a second position initiates one or more functional elements of device 200. For example, depression of button 250A into a second depressed position may actuate a scan routine and may invoke a scan controller or another operational device or subsystem responsible for control of scanning hardware and/or software modules of device 200. Likewise, depression of button 250A from a first depressed position to a second depressed position may invoke a print controller or another operational device or subsystem responsible for control of printing hardware and/or software modules of device 200 when device 200. Depression of button 250A from a first depressed position to a second depressed position may deactivate alignment elements 275A-275D as well. Alternatively, a button 250A may be a simple one-position push-button operatively coupled with one or more alignment elements 275A-275D such that depression thereof actuates the one or more alignment elements. Other push-buttons 250B-250C or 251A-251E may be operatively coupled with one or more functional device elements such as a scan controller, print controller and/or other device hardware and/or software.

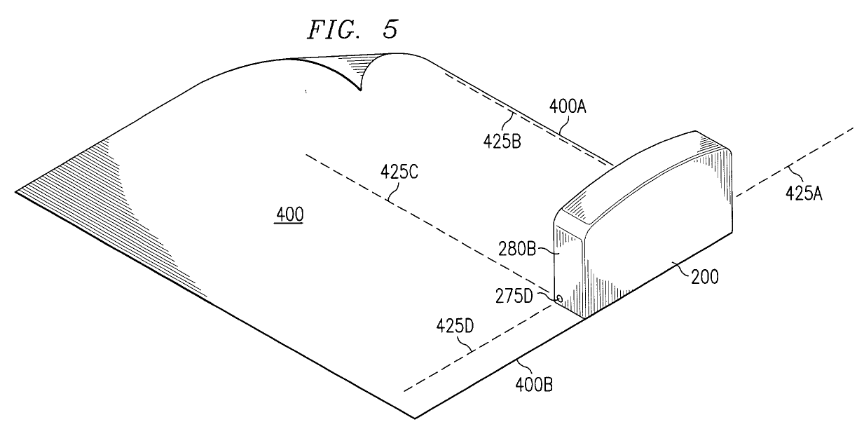

In FIG. 5, there is shown a simplified top schematic of portable device 200 positioned on a document 400 for performing a scan, print, or another operation according to an embodiment of the present invention. In the illustrative example, device 200 is equipped with four alignment elements although a greater or lesser number of alignment elements may be employed for facilitating accurate alignment of device 200 on a document 400. Two alignment element elements 275B and 275C are disposed on anterior surface 230 and two additional alignment elements 275A and 275D are disposed on respective side surfaces 280A and 280B. After device 200 is positioned on document 400 or another object, alignment elements 275A-275D may be actuated by, for example, depression of button 250A or another actuation element operatively coupled therewith. In a preferred embodiment, each of alignment elements 275A-275D are laser emitters that respectively emit laser light 425A-425D (illustratively denoted with dashed lines) upon actuation thereof that is projected along a surface of document 400 when device 200 is positioned in abutment therewith. Alignment elements, such as alignment elements 275A and 275B, orthogonally disposed within device 200 project laser lights 425A and 425B that are mutually orthogonal. Accordingly, appropriate alignment of device 200 is facilitated by positioning device 200 on document 400 and visually aligning one or more of emitted laser light 425A-425D with a longitudinal or lateral axis of a region of interest such as defined by document edges 400A and 400B.

As described, a device and method for facilitating alignment of a portable imaging device with a region of interest of an object is provided. An alignment element is actuated and projects an alignment light along an axis of the imaging device. Projection of the alignment light enables a user of the device to align the device with an axis of an object, such as an edge of a document, and thereby avert introduction of skew, or another undesirable artifact, in a scanned or printed image.

What is claimed is:

1. An imaging device comprising:
an actuation element externally disposed on the imaging device; and
a first alignment element communicatively coupled with the actuation element and operable to emit an alignment light upon actuation of the actuation element, the alignment light emitted in parallel with a surface of the imaging device.

2. The device according to claim 1, further comprising an external house comprising an aperture, the alignment element disposed within the imaging device and oriented such that the alignment light is projected through the aperture.

3. The device according to claim 2, wherein a second alignment element is disposed within the imaging device orthogonally with the first alignment element.

4. The device according to claim 1, wherein the device components comprise at least one of printer components and scanner components.

5. The device according to claim 1, wherein the actuation element is a pushbutton.

6. The device according to claim 1, wherein the actuation element is a multi-positional push-button communicatively coupled to at least one of the device components.

7. The device according to claim 6, wherein depression of the multi-positional push button into a first position actuates the first alignment element and depression of the multi-positional push button into a second position actuates at least one of the device components.

8. The device according to claim 7, wherein depression of the multi-positional push button into the second position also deactivates the first alignment element.

9. The device according to claim 1, further comprising a plurality of actuation elements, wherein depression of a first actuation element activates the first alignment element and depression of a second actuation element activates at least one of the device components.

10. The device according to claim 1, further comprising a local interface, the actuation element and the first alignment element communicatively coupled to the local interface.

11. The device according to claim 1, wherein the alignment element comprises at least one of a laser emitter and a light emitting diode.

12. The device according to claim 1, further comprising a plurality of alignment elements operatively coupled to the actuation element.

13. The device according to claim 1, wherein a first alignment light emitted from the first alignment element is mutually orthogonal with a second alignment light emitted from a second alignment element.

14. A method of aligning a portable imaging device with an object, comprising:
actuating an input element communicatively coupled to an alignment element; and
emitting at least one alignment light from the alignment element.

15. The method according to claim 14, further comprising positioning a surface of the device in abutment with a surface of the object.

16. The method according to claim 14, wherein emitting at least one alignment light further comprises emitting an alignment light substantially parallel with a surface of the object.

17. The method according to claim 14, wherein emitting at least one alignment light further comprises emitting a first alignment light orthogonally to an emission of a second alignment light.

18. The method according to claim 14, wherein emitting at least one alignment light further comprises emitting an alignment light from at least one of a laser emitter and a light emitting diode.

19. The method according to claim 14, wherein actuating an input element further comprising depressing a push-button.
